(19) United States
(12) Patent Application Publication
(10) Pub. No.: US 2013/0033422 A1
(43) Pub. Date: Feb. 7, 2013

(54) ELECTRONIC APPARATUS USING MOTION RECOGNITION AND METHOD FOR CONTROLLING ELECTRONIC APPARATUS THEREOF

(71) Applicants: Chan-hee CHOI, Seoul (KR); Hee-seob RYU, Hwaseong-si (KR); Dong-ho LEE, Seoul (KR); Ki-jun JEONG, Seoul (KR); Seung-kwon PARK, Yongin-si (KR); Sang-jin HAN, Gunpo-si (KR)

(72) Inventors: Chan-hee CHOI, Seoul (KR); Hee-seob RYU, Hwaseong-si (KR); Dong-ho LEE, Seoul (KR); Ki-jun JEONG, Seoul (KR); Seung-kwon PARK, Yongin-si (KR); Sang-jin HAN, Gunpo-si (KR)

(73) Assignee: SAMSUNG ELECTRONICS CO., LTD., Suwon-si (KR)

(21) Appl. No.: 13/567,298

(22) Filed: Aug. 6, 2012

Related U.S. Application Data
(60) Provisional application No. 61/515,459, filed on Aug. 5, 2011.

(30) Foreign Application Priority Data
Nov. 11, 2011 (KR) 10-2011-0117849

(51) Int. Cl. G06F 3/01

(52) U.S. Cl. 345/156

(57) ABSTRACT

An electronic apparatus and controlling method thereof is disclosed. The method for controlling the electronic apparatus includes using motion recognition photographs as an object, and changing and displaying a screen based on a movement direction of the object, when a determination that the photographed object is moved while maintaining a first shape is made. By this method, the user is able to perform zoom in and zoom out operations more easily and intuitively by using motion recognition.

### CROSS-REFERENCE TO RELATED APPLICATIONS

This application claims the benefit of U.S. Provisional Patent Application No. 61/515,459, filed on Aug. 5, 2011, in the U.S. Patent and Trademark Office, and priority from Korean Patent Application No. 10-2011-0117849, filed on Nov. 11, 2011 in the Korean Intellectual Property Office, the disclosures of which are incorporated herein by reference in their entireties.

### BACKGROUND OF THE INVENTION

1. Field of the Invention

Methods and apparatuses consistent with exemplary embodiments relate to an electronic apparatus and a method for controlling the electronic apparatus thereof, and more particularly to an electronic apparatus which is controlled according to a motion of an object photographed by a photographing unit, and a controlling method thereof

2. Description of the Prior Art

Various electronic apparatuses are being developed and distributed based on corresponding developments of electronic technologies. In particular, recently, various types of electronic apparatuses, including televisions (TVs), are being used at residential homes.

These electronic apparatuses have been provided with various functions in accordance with user demands. For instance, TVs provide not only broadcast receiving functions, but they are also connected to the internet, in order to provide internet services. Furthermore, TVs have become able to provide and/or display a variety of types of contents by executing functions which provide the various contents, such as, for example, photographs and video images.

However, when providing contents using such an electronic apparatus, there exists a problem of not being able to perform zoom in or zoom out operations on the contents by using simple input methods. For example, when displaying a photograph on a TV, there is a problem of not being able to easily zoom in or zoom out on a selected portion of the photograph by using a remote control.

There exists another problem that, in order to navigate a contents list provided by such an electronic apparatus, an additional input apparatus, such as, for example, a mouse, is necessary.

### SUMMARY OF THE INVENTION

An aspect of the exemplary embodiments relates to an electronic apparatus which performs zoom in or zoom out operations based on a movement of an object photographed by a photographing unit by using motion recognition, and a controlling method thereof.

According to an exemplary embodiment of the present disclosure, a method for controlling an electronic apparatus by using motion recognition may include photographing an object; and changing and displaying a screen based on a first movement direction of the object, when a determination that the photographed object has moved while maintaining a first shape is made.

The object may be a user's hand, and the method may further include detecting a first shape of the user's hand as a grab shape.

The method may further include determining a detected location of the user's hand; and changing the screen based on the detected location.

The method may include causing a cursor included in the screen not to move while changing and displaying the screen.

The method may further include displaying a screen relating to when the first shape is released when a determination that the first shape of the object has been released is made.

The method may further include moving a cursor included in the display screen based on a second movement direction of the object while maintaining a second shape, when a determination is made that the object has moved while maintaining the second shape after the first shape of the object has been released.

According to an exemplary embodiment of the present disclosure, an electronic apparatus which performs motion recognition may include a display unit; a photographing unit which photographs an object; and a control unit which controls the display unit to change and display a screen based on a first movement direction of the object, when a determination that the photographed object has moved while maintaining a first shape is made.

The object may be a user's hand, and a first shape of the user's hand may be a grab shape.

The control unit may determine a detected location of the user's hand, and control the display unit to change the screen based on the detected location.

The control unit may cause a cursor included in the screen not to move while controlling the display unit to change and display the screen.

The control unit may control the display unit to display a screen relating to when the first shape is released when a determination that the first shape of the object has been released is made.

The control unit may control the display unit to move a cursor included in the display screen based on a second movement direction of the object while maintaining a second shape, when a determination is made that the object is moved while maintaining the second shape after the first shape of the object has been released.

According to an exemplary embodiment of the present disclosure, a method for controlling an electronic apparatus by using motion recognition may include photographing a first object and a second object; determining that the photographed first object and the photographed second object have moved while maintaining a first shape; and zooming in or zooming out a screen based on a movement direction of the first object and the second object.

The first object may be a user's left hand and the second object may be the user's right hand, and the zooming in or out may occur when the left hand and the right hand are moved while maintaining symmetry therebetween.

The zooming in or out may occur when the left hand and the right hand are moved in one of an up/down direction, a left/right direction, and a diagonal direction.

The zooming in or out may comprise zooming out the screen when the left hand and the right hand are moved toward a center point with respect to the left hand and the right hand.

The zooming in or out may comprise zooming in the screen when the left hand and the right hand are moved away from each other.

According to an exemplary embodiment of the present disclosure, an electronic apparatus which performs motion recognition may include a display unit; a photographing unit which photographs a first object and a second object; and a control unit which controls the display unit to zoom in or zoom out a screen based on respective movement directions of the first object and the second object, when a determination that the photographed first object and the photographed second object have moved while maintaining a first shape.

The first object may be a user's left hand and the second object may be the user's right hand, and the control unit may zoom in or zoom out a screen of the display unit when the left hand and the right hand are moved while maintaining symmetry therebetween.

The control unit may zoom in or zoom out the screen when the left hand and the right hand are moved in one of an up/down direction, a left/right direction, and a diagonal direction.

The control unit may zoom out the screen when the left hand and the right hand are moved toward a center point with respect to the left hand and the right hand.

The control unit may zoom in the screen when the left hand and the right hand are moved away from each other.

According to an exemplary embodiment of the present disclosure, a method for controlling an electronic apparatus by using motion recognition may include photographing an object; determining that the photographed object has moved while maintaining a first shape; and zooming in or zooming out a display screen based on a movement direction of the object.

The object may be one of a user's left hand and the user's right hand, and the zooming in or zooming out may comprise zooming in the display screen when the object is moved in one of an upward direction and a rightward direction, and the zooming in or zooming out may comprise zooming out the display screen when the object is moved in one of a downward direction and a leftward direction.

The object may be one of a user's left hand and the user's right hand, and the zooming in or zooming out may comprise zooming in the display screen when the object is moved while rotating in one of a clockwise direction and a counterclockwise direction, and the zooming in or zooming out may comprise zooming out the display screen when the object is moved while rotating in an opposite one of the clockwise direction and the counterclockwise direction.

The object may be one of a user's left hand and the user's right hand, and the zooming in or zooming out may comprise zooming in the display screen when the object is moved inwardly with respect to the screen, and the zooming in or zooming out may comprise zooming out the display screen when the object is moved outwardly with respect to the screen.

According to an exemplary embodiment of the present disclosure, an electronic apparatus which performs motion recognition may include a display unit; a photographing unit which photographs an object; and a control unit which zooms in or zooms out on a screen of the display unit based on a movement direction of the object, when a determination that the photographed object has moved while maintaining a first shape is made.

The object may be one of a user's left hand and the user's right hand, and the control unit may zoom in the display screen when the object is moved in one of an upward direction and a rightward direction, and the control unit may zoom out the display screen when the object is moved in one of a downward direction and a leftward direction.

The object may be one of a user's left hand and the user's right hand, and the control unit may zoom in the display screen when the object is moved while rotating in one of a clockwise direction and a counterclockwise direction, and the control unit may zoom out the display screen when the object is moved while rotating in an opposite one of the clockwise direction and the counterclockwise direction.

The object may be one of a user's left hand and the user's right hand, and the control unit may zoom in the display screen when the object is moved inwardly with respect to the screen, and the control unit may zoom out the display screen when the object is moved outwardly with respect to the screen.

### BRIEF DESCRIPTION OF THE DRAWINGS

The above and/or other aspects of the present disclosure will be more apparent by describing certain exemplary embodiments with reference to the accompanying drawings, in which:

FIG. 1 is a block diagram illustrating a configuration of an electronic apparatus according to an exemplary embodiment of the present disclosure;

FIGS. 2A, 2B, 2C, and 2D are views which illustrate zoom in operations using two hands, according to various exemplary embodiments of the present disclosure;

FIGS. 3A, 3B, 3C, and 3D are views which illustrate zoom out operations using two hands, according to various exemplary embodiments of the present disclosure;

FIG. 4 is a view which illustrates zoom in/zoom out operations using one hand, according to a first exemplary embodiment of the present disclosure;

FIGS. 5A and 5B are views which illustrate zoom in/zoom out operations using one hand, according to a second exemplary embodiment of the present disclosure;

FIGS. 6A and 6B are views which illustrate zoom in/zoom out operations using one hand, according to a third exemplary embodiment of the present disclosure;

FIGS. 7A and 7B are views which illustrate a method for navigating a contents list, according to an exemplary embodiment of the present disclosure;

FIGS. 8A and 8B are views which illustrate a method for executing an icon on a contents list, according to an exemplary embodiment of the present disclosure;

FIG. 9 is a flowchart which illustrates a control method of an electronic apparatus for performing zoom in/zoom out operations by using motion recognition, according to an exemplary embodiment of the present disclosure; and

FIG. 10 is a flowchart which illustrates a control method of an electronic apparatus for performing navigation on a contents list by using motion recognition, according to an exemplary embodiment of the present disclosure.

### DETAILED DESCRIPTION

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. In addition, well-known functions or constructions are not described in detail, because they would obscure the application with unnecessary detail.

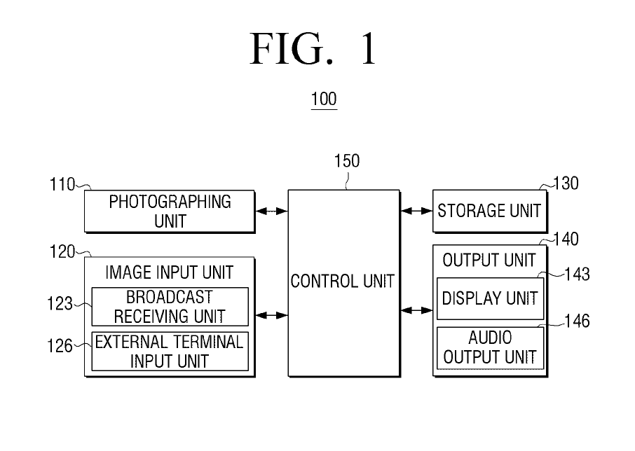

FIG. 1 is a block diagram illustrating a configuration of an electronic apparatus 100, according to an exemplary embodiment of the present disclosure. As illustrated in FIG. 1, the electronic apparatus 100 includes a photographing unit 110, an image input unit 120, a storage unit 130, an output unit 140, and a control unit 150. Herein, the electronic apparatus 100 may be embodied as a television (TV), tablet personal computer (PC), and/or as a mobile phone, but this is merely an exemplary embodiment, and thus the technological concept of the present disclosure may be applied to any electronic apparatus which is capable of using voice recognition and motion recognition.

The photographing unit 110 photographs an object (for example, a user's palm, fist, and/or finger) and provides the photograph of the object to the control unit 150. For example, the photographing unit 110 may be embodied as a camera, but this is merely an exemplary embodiment, and thus the photographing unit 110 may be embodied as a depth camera as well, or any other type of camera or apparatus which is capable of photographing an object.

The photographing unit 110 may be located, for example, at a center of a left side of a bezel positioned at outskirts of a display unit 143 which is included in the output unit 140. However, this is merely an exemplary embodiment, and thus the photographing unit 110 may be located at a different area of the electronic apparatus 100, and further, it may be separated and located externally with respect to the electronic apparatus 100. In a case where the photographing unit is separated from the electronic apparatus 100, the separated photographing unit 110 may be connected or electrically coupled to the electronic apparatus 100.

The image input unit 120 receives an image from outside. In particular, the image input unit 120 may include a broadcast receiving unit 123 and an external terminal input unit 126. The broadcast receiving unit 123 seeks a broadcast channel signal transmitted from an external broadcasting station, and performs signal processing on the sought broadcast channel signal. The external terminal input unit 126 may receive an image signal from an external device, such as, for example, a digital video disk (DVD), a PC, or a set top box.

The storage unit 130 stores various data and programs for driving and controlling the electronic apparatus 100. In particular, the storage unit 130 may store a motion recognition module for recognizing a user's motion received via the photographing unit 110. In addition, the storage unit 130 may store a motion database. The motion database refers to a database where the user's motion and a respective motion task which corresponds to each user's motion are stored in conjunction with each other. Herein, a task of the electronic apparatus 100 refers to a function such as channel changing, volume changing, and web browsing which can be performed by the electronic device 100.

The output unit 140 outputs image data which has been signal processed and audio data corresponding to the image data. Herein, the image data may be outputted by the display unit 143, and the audio data may be outputted by an audio output unit 146. The audio output unit 146 may include, for example, at least one of a speaker, a headphone output terminal, or a Sony/Philips Digital Interconnect Format (S/PDIF) output terminal.

The control unit 150 controls overall operations of the electronic apparatus 100 according to a user's command. In particular, the control unit 150 may control the photographing unit 110, the image input unit 120, the storage unit 130, and the output unit 140 according to the user's command. The control unit 150 may include a CPU (central processing unit), modules for controlling the electronic apparatus 100, and ROM (Read Only Memory) and RAM (Random Access Memory) for storing the modules.

The control unit 150 may recognize the user's motion received via the photographing unit 110 by using a motion recognition module stored in the storage unit 130.

More specifically, in a case where an object is photographed by using the photographing unit 110, the control unit 150 recognizes a motion by using a motion sensing module and motion database. In a case where an object is photographed by the photographing unit 110, the control unit 150 stores a received image in frame units, and senses the object subject to the user's motion (for instance, the user's hand) by using the stored frame. The motion sensing module senses at least one of a shape, a color, and a movement of the object included in the frame and thus detects the object.

The control unit 150 may track a movement of the detected object. In addition, the control unit 150 may eliminate noise not relating to the movement of the object.

The control unit 150 determines a motion based on a shape and location of the tracked object. The control unit 150 determines a positional change, a speed, a location, and a rotational direction of a shape of the object, to determine the user's motion. The user's motion may include, for example, one or more of a grab which is a motion of holding a hand, a pointing move which is a motion of moving a marked cursor using a hand, a slap which is a motion of moving a hand in one direction at a certain speed or more, a shake which is a motion of swinging a hand in either of a left/right direction or an up/down direction, and a rotation which is a motion of circulating a hand. The technological concept of the present disclosure may also be applied to motions other than the aforementioned exemplary embodiments. For example, a spread motion, which is a motion of unfolding a hand, may be further included.

In particular, the control unit 150 detects the photographed object, tracks the movement of the detected object (for example, the user's hand), and zooms in or zooms out on a screen of the display unit based on the tracked movement of the object.

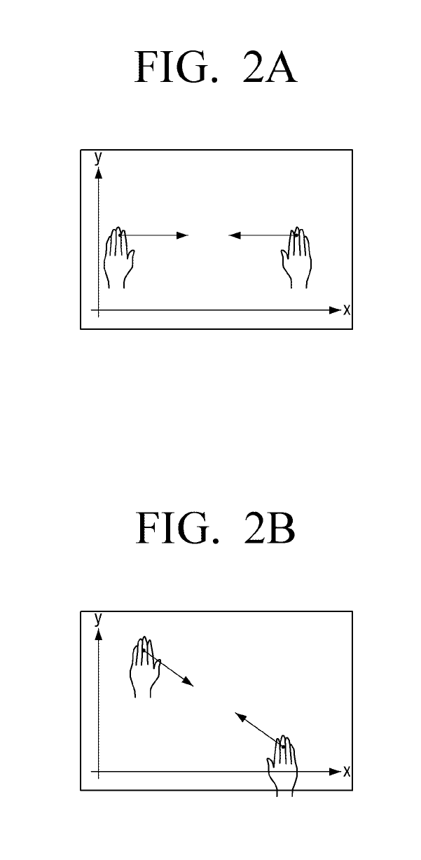

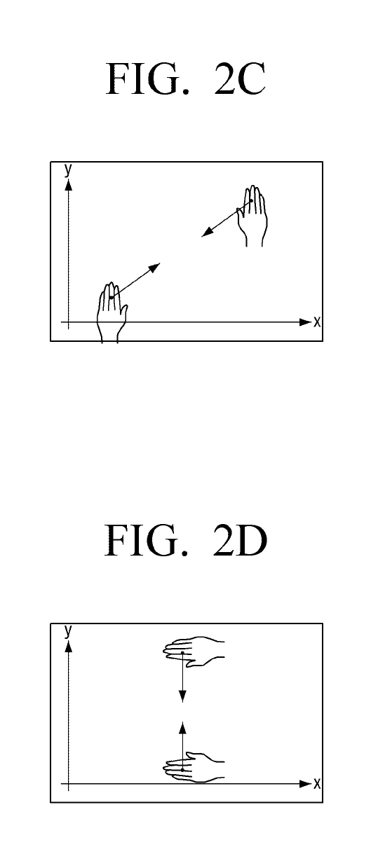

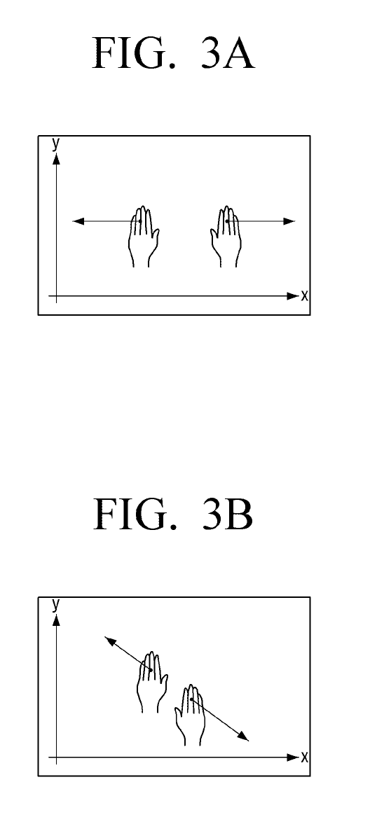

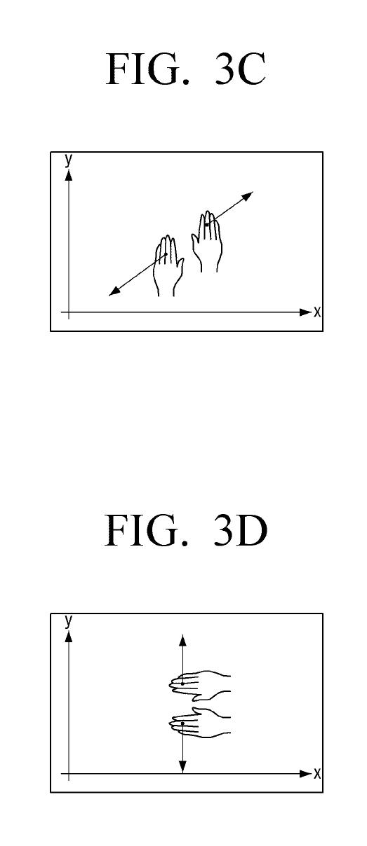

The following text provides a description of a method of the control unit 150 for performing a zoom in or zoom out operation by using two hands, with reference to FIGS. 2A, 2B, 2C, 2D, 3A, 3B, 3C, and 3D.

First, the control unit 150 detects the user's two hands, which are photographed by the photographing unit 110. In particular, the control unit 150 may detect two hands using at least one of a shape, a color, and a movement of the user's two hands. Further, a user's hand refers to at least one of a palm, a fist, and a finger of the user.

In particular, in a case where a grab motion, which is a motion of the user holding two hands, is photographed, the control unit 150 may detect the grab motion and thusly detect the user's two hands. Alternatively, in a case where a shake motion of the user shaking the two hands several times is photographed, the control unit 150 may detect the shake motion and thusly detect the user's two hands. In another alternative, in a case where a motion of the user holding the palm still for a predetermined time (for example, 5 seconds) is photographed, the control unit 150 may detect the palm, and thusly detect the two hands.

In any case where the two hands are detected, the control unit 150 may display an icon which includes information relating to the detection of the two hands on a display screen.

When the two hands are detected, the control unit 150 determines whether or not the two hands have been moved while maintaining a first shape (for example, a state where the palm is unfolded) and while maintaining symmetry between the two hands. In addition, when it is determined that the two hands have been moved while maintaining the first shape and while maintaining symmetry therebetween, the control unit 150 performs one of a zoom in and zoom out operation with respect to the display screen based on the movement direction of the two hands.

In particular, when the user's two hands are moved toward a central point with respect to the two hands while maintaining symmetry therebetween, the control unit 150 zooms out the display screen. For example, as illustrated in FIG. 2A, when the user's left hand is moved to the right and the user's right hand is moved to the left while maintaining symmetry between the user's left hand and the user's right hand, the control unit 150 may zoom out the display screen. Further, as illustrated in FIG. 2B, when the user's left hand is moved diagonally in a downward and rightward direction and the user's right hand is moved diagonally in an upward and leftward direction while maintaining symmetry between the user's left hand and the user's right hand, the control unit 10 may zoom out the display screen. Still further, as illustrated in FIG. 2C, when the user's left hand is moved diagonally in an upward and rightward direction and the user's right hand is moved diagonally in a downward and leftward direction while maintaining symmetry between the user's left hand and the user's right hand, the control unit 150 may zoom out the display screen. Still further, as illustrated in FIG. 2D, when whichever hand of the user's left and right hand is located in the higher relative position is moved in a downward direction and the other hand is moved in an upward direction while maintaining symmetry between the two hands, the control unit 150 may zoom out the display screen.

When the user's two hands are moved outwards away from each other while maintaining symmetry therebetween, the control unit 150 zooms in the display screen. For example, as illustrated in FIG. 3A, when the user's left hand is moved to the left and the user's right hand is moved to the right while maintaining symmetry between the user's left hand and the user's right hand, the control unit 150 may zoom in the display screen. Further, as illustrated in FIG. 3B, when the user's left hand is moved diagonally in an upward and leftward direction and the user's right hand is moved diagonally in a downward and rightward direction while maintaining symmetry between the user's left and right hands, the control unit 150 may zoom in the display screen. Still further, as illustrated in FIG. 3C, when the user's left hand is moved diagonally in a downward and leftward direction and the user's right hand is moved diagonally in an upward and rightward direction while maintaining symmetry between the user's left and right hands, the control unit 150 may zoom in the display screen. Still further, as illustrated in FIG. 3D, when whichever hand of the user's left and right hand is located in the higher relative position is moved in an upward direction and the other hand is moved in a downward direction while maintaining symmetry between the two hands, the control unit 150 may zoom in the display screen.

Meanwhile, as illustrated in FIGS. 2A, 2B, 2C, 2D, 3A, 3B, 3C, and 3D, even if the two hands do not maintain symmetry therebetween when they are moved, when they are moved closer to each other, the control unit 150 may zoom out the display screen. Further, when the two hands are moved away from each other, the control unit 150 may zoom in the display screen.

In addition, in a state where one hand is kept still and the other hand is moved closer to the hand which is kept still, the control unit 150 may zoom out the display screen. Further, in a state where one hand is kept still and the other hand is moved away from the hand which is kept still, the control unit 150 may zoom in the display screen.

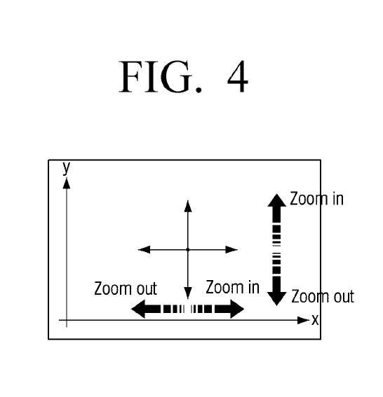

The following text provides a description of a method of the control unit 150 for performing a zoom in or zoom out operation by using one hand, with reference to FIGS. 4, 5A, 5B, 6A, and 6B.

First, the control unit 150 detects a user's one hand, which is photographed by the photographed unit 110. In particular, the control unit 150 may detect the one hand by using at least one of a shape, a color, and a movement of one or both of the user's two hands.

A method of detecting one hand may be the same as the method of detecting two hands, as described above. For example, in a case where a grab motion, a shake motion of shaking one hand several times, or a motion where one hand is kept still for a predetermined time, is photographed by using the photographing unit 110, the control unit 150 may detect one hand.

When one hand is detected, the control unit 150 determines whether or not the detected one hand is moved while maintaining a first shape, such as, for example, a state where the detected one hand is kept unfolded. Further, the control unit 150 performs one of a zoom in and zoom out operation with respect to the display screen based on the movement direction of the detected one hand.

For example, in a case where the movement direction of the detected one hand is one of an upward direction and a rightward direction, the control unit 150 zooms in the display screen, as illustrated in FIG. 4. However, in a case where the movement direction of the detected one hand is one of a downward direction and a leftward direction, the control unit 150 zooms out the display screen.

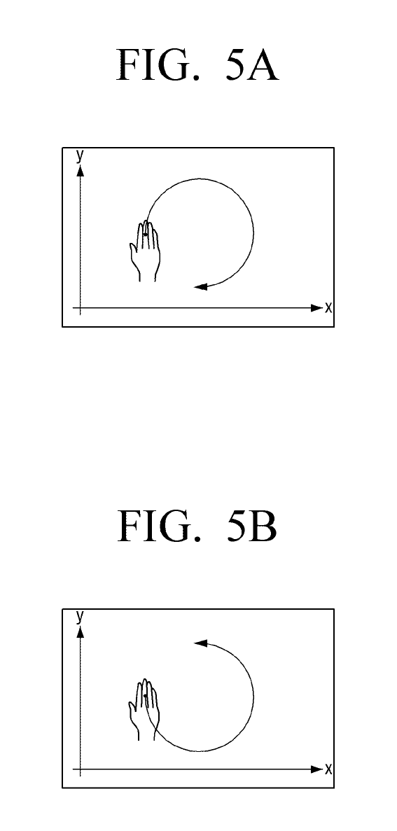

Further, in a case where the movement direction of the detected one hand is a clockwise rotating direction, the control unit 150 zooms in the display screen, as illustrated in FIG. 5A. Conversely, in a case where the movement direction of the detected one hand is a counterclockwise rotating direction, the control unit 150 zooms out the display screen, as illustrated in FIG. 5B. However, the zoom in and zoom out operations illustrated in FIGS. 5A and 5B are merely exemplary embodiments of the present disclosure, and thus the display screen may be zoomed out when the detected one hand is rotated in the clockwise direction, and the display screen may be zoomed in when the detected one hand is rotated in the counterclockwise direction.

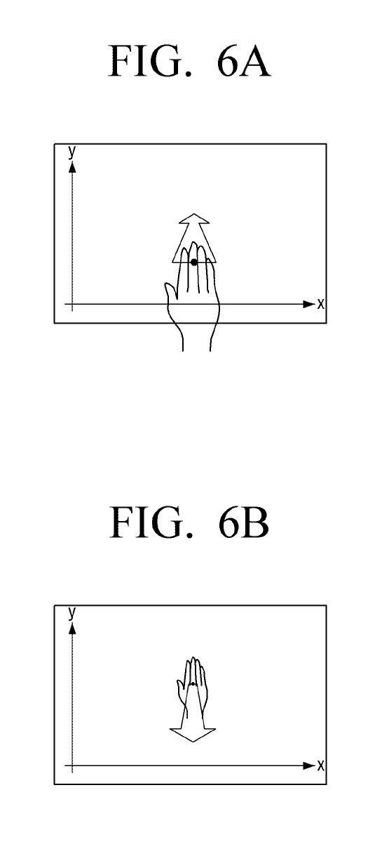

Still further, in a case where the detected one hand is moved inwardly with respect to the display screen of the electronic apparatus, the control unit 150 zooms in the display screen, as illustrated in FIG. 6A. Conversely, in a case where the detected one hand is moved outwardly with respect to the screen, the control unit 150 zooms out the display screen, as illustrated in FIG. 6B.

However, the exemplary embodiments of performing zoom in/zoom out operations with respect to a detection of one hand as described above with respect to FIGS. 4, 5A, 5B, 6A, and 6B may be applied only when zoom in/zoom out operations of the display screen are possible, such as, for example, for a photograph or a web page, or when the electronic apparatus 100 has entered into a zoom in/zoom out mode of the display screen.

By performing zoom in/zoom out operations as described above, the user becomes able to perform zoom in and zoom out operations more easily and intuitively by using motion recognition.

Further, when it is recognized that the object photographed by the photographing unit 110 is moved while maintaining the first shape, the control unit 150 controls the display unit 143 to move the screen in the movement direction of the object and then display the screen. In particular, the screen may display a list including a plurality of icons or thumbnails, but this is merely an exemplary embodiment, and thus the technological concept of the present disclosure may be applied to any screen which can be moved. In addition, the first shape may be, for example, a grab shape.

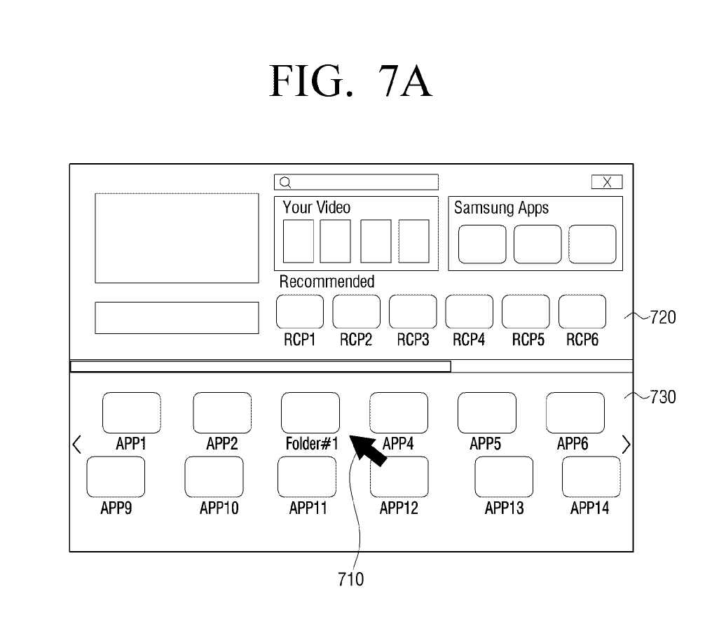

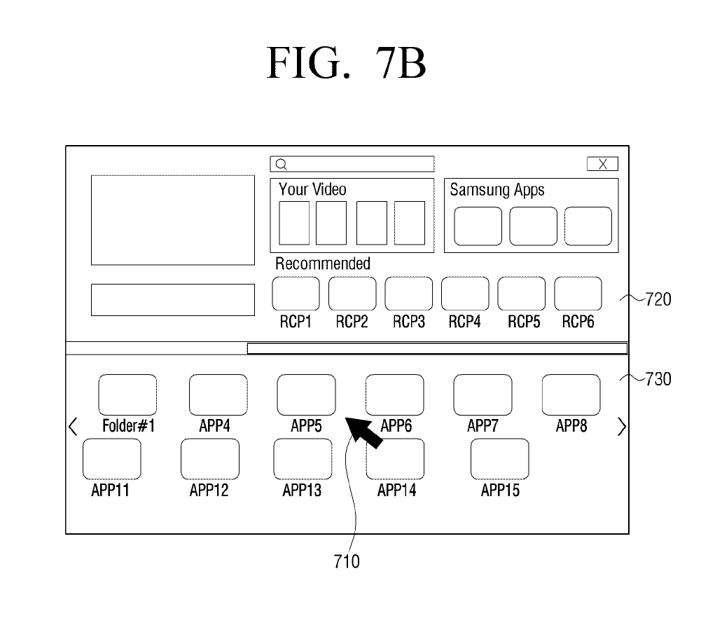

For example, as illustrated in FIG. 7A, in a state where a contents list screen 720 which includes a plurality of application icons 730 is displayed, when it is recognized that the user's hand, which has been photographed by the photographing unit 110, has moved while maintaining a grab motion, the control unit 150 may move the contents list screen 720 in the movement direction corresponding to the grab motion and then display the contents list screen. Accordingly, when it is recognized that the user's hand, which has been photographed by the photographing unit 110, has moved in a leftward direction while maintaining the grab motion on the contents list screen 720 as illustrated in FIG. 7A, the control unit 150 may move the contents list screen 720 to the right and then display the contents list screen 720, as illustrated in FIG. 7B.

On the contrary, when it is recognized that the user's hand, which has been photographed by the photographing unit 110, has moved in a rightward direction while maintaining the grab motion on the contents list screen 720, as illustrated in FIG. 7B, the control unit 150 may move the contents list screen 720 to the left and then display the contents list screen 720, as illustrated in FIG. 7A.

Herein, even when the object is moved while maintaining the first shape, a display cursor 710 on the display screen does not move.

Further, when it is determined that the first shape is released and the object is moved while maintaining a second shape, such as, for example, a state where only one finger is unfolded, the control unit 150 may move the cursor 710 included in the display screen in the movement direction of the object which maintained the second shape.

In particular, FIGS. 7A and 7B illustrate only an area of the contents list screen where the cursor exists, but this is merely an exemplary embodiment, and thus the entire screen may move.

Further, FIGS. 7A and 7B respectively illustrate cases where the contents list screen is moved to the left and right, but this is also merely an exemplary embodiment, and thus it is possible to apply the technological concept of the present disclosure to cases where the contents list screen is moved in one or more of an upward direction, a downward direction, and a diagonal direction.

Still further, when it is recognized that the grab motion of the user photographed by the photographing unit 110 is released, the control unit 150 controls the display unit 143 to display the contents list screen corresponding to the point when the grab motion was released.

Still further, when the first motion of the object is photographed by the photographing unit 110 in a circumstance where the cursor is located on one of the plurality of icons displayed on the contents list, the control unit 150 may execute the icon where the cursor is located.

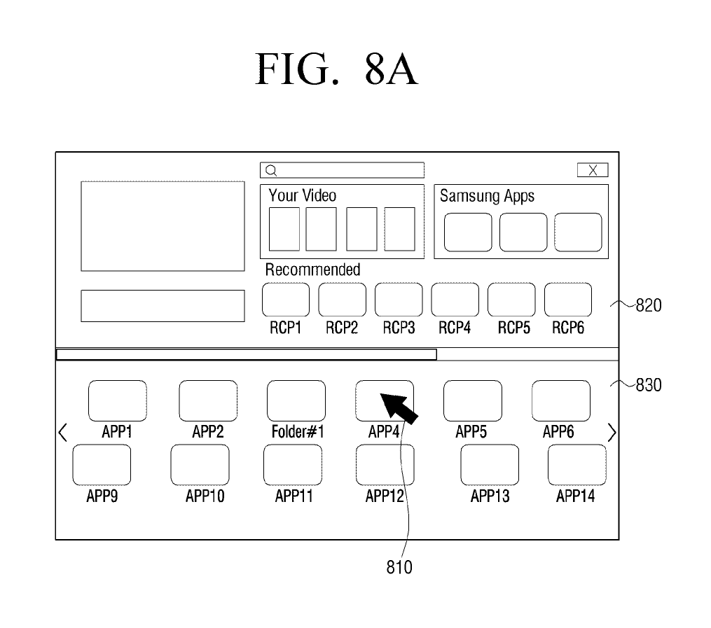

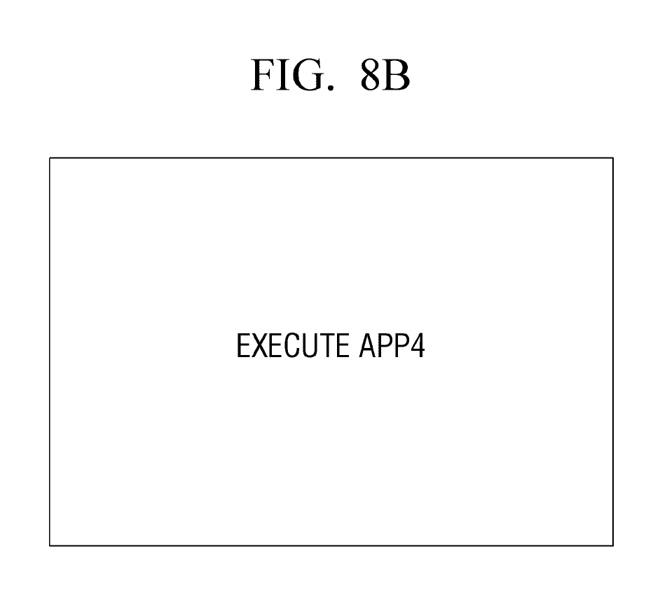

For example, as illustrated in FIG. 8A, in a case where the user's hand, which has been photographed by the photographing unit 110, performs the grab motion in a circumstance where the cursor 810 is located on the icon APP4 from the plurality of application icons 830 on the contents list screen 820, the control unit 150 may execute the icon APP 4 as illustrated in FIG. 8B.

In particular, the control unit 150 may execute the icon immediately when the user's hand performs the grab motion, but this is merely an exemplary embodiment, and thus, for example, the control unit 150 may execute the icon at a time when the user unfolds the hand again after performing the grab motion.

Accordingly, FIGS. 7A, 7B, 8A, and 8B are based on an assumption that the present disclosure is applied to a contents list screen, but this is merely an exemplary embodiment, and thus, for example, the technological concept of the present disclosure may be applied to a screen which is moveable, such as, for example, a web page.

As illustrated in FIGS. 7A, 7B, 8A, and 8B, by moving the display screen, the user becomes able to more easily and conveniently navigate the contents list screen without the use of an input device such as a remote control.

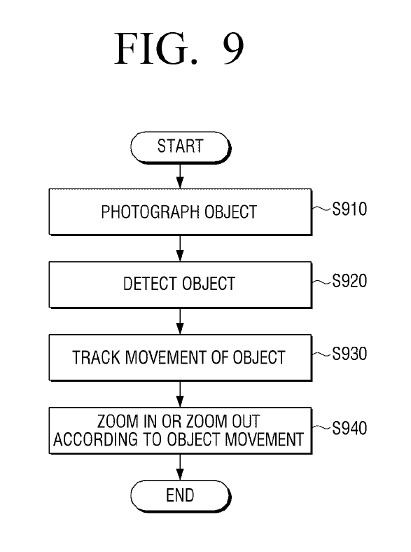

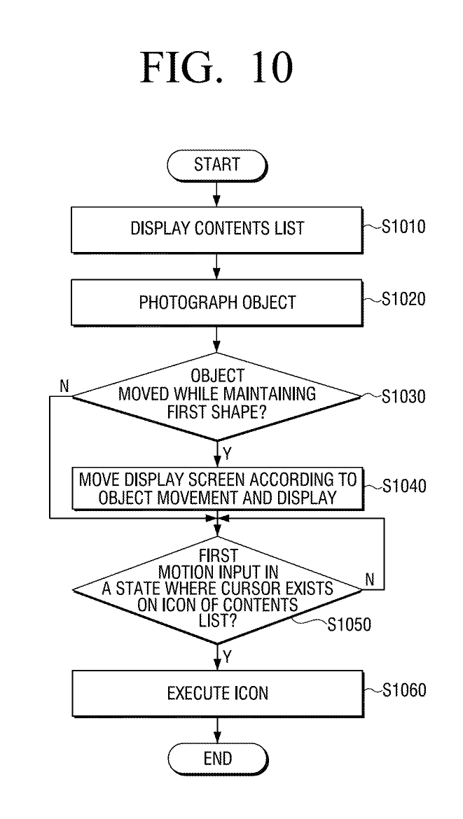

The following text provides a detailed description of a method for controlling the electronic apparatus by using motion recognition according to an exemplary embodiment, with reference to FIGS. 9 and 10.

FIG. 9 is a flowchart which illustrates a method for controlling the electronic apparatus 100 which performs zoom in/zoom out operations by using motion recognition, according to an exemplary embodiment of the present disclosure.

First, the electronic apparatus 100 photographs an object (operation S910). In particular, the electronic apparatus 100 may photograph the object by using, for example, a camera or a depth camera.

Next, the electronic apparatus 100 detects the photographed object (operation S920). More specifically, the electronic apparatus 100 may detect the object by using one of a shape, a color, and a movement of the object. In particular, the object may be a user's hand (for example, the user's palm, fist, and a finger). Further, in a case where the object is the user's hand, the user's hand may include either two hands or one hand.

For example, in a case where a grab motion relating to the user holding two hands is photographed, the electronic apparatus 100 may detect the grab motion and detect the user's two hands. Alternatively, in a case where a shake motion relating to the user shaking the two hands several times is photographed, the electronic apparatus 100 may detect the shake motion and detect the user's two hands. In a further alternative, in a case where a motion relating to the user keeping the palm still for a predetermined time (for example, 5 seconds) is photographed, the electronic apparatus 100 may detect the palm and detect the two hands.

Next, the electronic apparatus tracks the movement of the detected object (operation S930).

Lastly, the electronic apparatus 100 performs either of a zoom in operation or a zoom out operation based on the movement of the detected object (operation S940). More specifically, in a case where the detected object is the user's two hands, when a determination is made that the user's two hands have moved while maintaining symmetry therebetween, the electronic apparatus 100 performs one of a zoom in operation and a zoom out operation with respect to the display screen based on the movement of the two hands. In particular, when the two hands are moved toward each other, the electronic apparatus 100 may perform a zoom out operation, and when the two hands are moved away from each other, the electronic apparatus 100 may perform a zoom in operation. In a case where the object is the user's one hand, the electronic apparatus 100 may perform a zoom in operation or a zoom out operation, as illustrated in FIGS. 4, 5A, 5B, 6A, and 6B.

Accordingly, the user becomes able to perform a zoom in operation or a zoom out operation with respect to the display screen more easily and conveniently by using motion recognition.

FIG. 10 is a flowchart which illustrates a method for controlling the electronic apparatus in order to perform navigation of the contents list by using motion recognition, according to an exemplary embodiment of the present disclosure.

First, the electronic apparatus 100 displays the contents list (operation S1010). In particular, the contents list may be a list which includes a plurality of icons or a plurality of thumbnails.

Next, the electronic apparatus 100 photographs the object by using the photographing unit 110 (operation S1020).

Next, the electronic apparatus 100 determines whether or not the object (for example, the user's hand) has moved while maintaining the first shape (such as, for example, the grab shape) (operation S1030).

When a determination is made that the object has moved while maintaining the first shape (operation S1030-Y), the electronic apparatus 100 moves the display screen and displays, based on the movement of the object maintaining the first shape (operation S1040).

Next, the electronic apparatus 100 determines whether or not the first motion (for example, the grab motion) has occurred in a circumstance where the cursor is located on the icon of the contents list (operation S1050).

When a determination is made that the first motion has occurred in a circumstance where the cursor is located on the icon of the contents lists (operation S1050-Y), the electronic apparatus 100 executes the icon where the cursor is located (operation S1060).

By execution of the method illustrated in FIG. 10, the user may navigate the contents list screen more easily and conveniently by using motion recognition, and may execute the icon of the contents list.

The methods according to the exemplary embodiments of the present disclosure may be embodied as programs which can be executed by using one or more of various computer means, and be recorded in computer readable media. The computer readable media may store a program command, data file, data structure or a combination thereof. The program recorded in the aforementioned media may be one that is specially designed and configured based on the present disclosure.

Although a few exemplary embodiments according to the present inventive concept have been shown and described, it will be appreciated by those skilled in the art that changes may be made in these exemplary embodiments without departing from the principles and spirit of the present disclosure, the scope of which is defined in the claims and their equivalents.

What is claimed is:

1. A method for controlling an electronic apparatus by using motion recognition, the method comprising:
photographing an object; and
changing and displaying a screen based on a first movement direction of the object, when a determination that the photographed object has moved while maintaining a first shape is made.

2. The method according to claim 1, wherein the object is a user's hand, and the method further comprises detecting a first shape of the user's hand as a grab shape.

3. The method according to claim 2, further comprising:
determining a detected location of the user's hand; and
changing the screen based on the detected location.

4. The method according to claim 1, further comprising causing a cursor included in the screen not to move while changing and displaying the screen.

5. The method according to claim 1, further comprising displaying a screen relating to when the first shape is released when a determination that the first shape of the object has been released is made.

6. The method according to claim 1, further comprising moving a cursor included in the display screen based on a second movement direction of the object while maintaining a second shape, when a determination is made that the object has moved while maintaining the second shape after the first shape of the object has been released.

7. An electronic apparatus which performs motion recognition, the apparatus comprising:
a display unit;
a photographing unit which photographs an object; and
a control unit which controls the display unit to change and display a screen based on a first movement direction of the object, when a determination that the photographed object has moved while maintaining a first shape is made.

8. The apparatus according to claim 7, wherein the object is a user's hand, and a first shape of the user's hand is a grab shape.

9. The apparatus according to claim 8, wherein the control unit determines a detected location of the user's hand, and controls the display unit to change the screen based on the detected location.

10. The apparatus according to claim 7, wherein the control unit causes a cursor included in the screen not to move while controlling the display unit to change and display the screen.

11. The apparatus according to claim 7, wherein the control unit controls the display unit to display a screen relating to when the first shape is released when a determination that the first shape of the object has been released is made.

12. The apparatus according to claim 7, wherein the control unit controls the display unit to move a cursor included in the display screen based on a second movement direction of the object while maintaining a second shape, when a determination is made that the object has moved while maintaining the second shape after the first shape of the object has been released.

13. A method for controlling an electronic apparatus by using motion recognition, the method comprising:
photographing a first object and a second object;
determining that the photographed first object and the photographed second object have moved while maintaining a first shape; and
zooming in or zooming out a screen based on a movement direction of the first object and the second object.

14. The method according to claim 13, wherein the first object is a user's left hand and the second object is the user's right hand, and
the zooming in or out occurs when the left hand and the right hand are moved while maintaining symmetry therebetween.

15. The method according to claim 14, wherein the zooming in or out occurs when the left hand and the right hand are moved in one of an up/down direction, a left/right direction, and a diagonal direction.

16. The method according to claim 15, wherein the zooming in or out comprises zooming out the screen when the left hand and the right hand are moved toward a center point with respect to the left hand and the right hand.

17. The method according to claim 15, wherein the zooming in or out comprises zooming in the screen when the left hand and the right hand are moved away from each other.

18. An electronic apparatus which performs motion recognition, the apparatus comprising:
a display unit;
a photographing unit which photographs a first object and a second object; and
a control unit which controls the display unit to zoom in or zoom out a screen based on respective movement directions of the first object and the second object, when a determination that the photographed first object and the photographed second object have moved while maintaining a first shape.

19. The apparatus according to claim 18, wherein the first object is a user's left hand and the second object is the user's right hand, and
the control unit zooms in or zooms out the screen when the left hand and the right hand are moved while maintaining symmetry therebetween.

20. The apparatus according to claim 19, wherein the control unit zooms in or zooms out the screen when the left hand and the right hand are moved in one of an up/down direction, a left/right direction, and a diagonal direction.

21. The apparatus according to claim 20, wherein the control unit zooms out the screen when the left hand and the right hand are moved toward a center point with respect to the left hand and the right hand.

22. The apparatus according to claim 20, wherein the control unit zooms in the screen when the left hand and the right hand are moved away from each other.

23. A method for controlling an electronic apparatus by using motion recognition, the method comprising:
photographing an object;
determining that the photographed object has moved while maintaining a first shape; and
zooming in or zooming out a display screen based on a movement direction of the object.

24. The method according to claim 23, wherein the object is one of a user's left hand and the user's right hand, and
the zooming in or zooming out comprises zooming in the display screen when the object is moved in one of an upward direction and a rightward direction, and the zooming in or zooming out comprises zooming out the display screen when the object is moved in one of a downward direction and a leftward direction.

25. The method according to claim 23, wherein the object is one of a user's left hand and the user's right hand, and
the zooming in or zooming out comprises zooming in the display screen when the object is moved while rotating in one of a clockwise direction and a counterclockwise direction, and the zooming in or zooming out comprises zooming out the display screen when the object is moved while rotating in an opposite one of the clockwise direction and the counterclockwise direction.

26. The method according to claim 23, wherein the object is one of a user's left hand and the user's right hand, and
the zooming in or zooming out comprises zooming in the display screen when the object is moved inwardly with respect to the screen, and the zooming in or zooming out comprises zooming out the display screen when the object is moved outwardly with respect to the screen.

27. An electronic apparatus which performs motion recognition, the apparatus comprising:
a display unit;
a photographing unit which photographs an object; and
a control unit which zooms in or zooms out a screen of the display unit based on a movement direction of the object, when a determination that the photographed object has moved while maintaining a first shape is made.

28. The apparatus according to claim 27, wherein the object is one of a user's left hand and the user's right hand, and
the control unit zooms in the display screen when the object is moved in one of an upward direction and a rightward direction, and the control unit zooms out the display screen when the object is moved in one of a downward direction and a leftward direction.

29. The apparatus according to claim 27, wherein the object is one of a user's left hand and the user's right hand, and
the control unit zooms in the display screen when the object is moved while rotating in one of a clockwise direction and a counterclockwise direction, and the control unit zooms out the display screen when the object is moved while rotating in an opposite one of the clockwise direction and the counterclockwise direction.

30. The apparatus according to claim 27, wherein the object is one of a user's left hand and the user's right hand, and
the control unit zooms in the display screen when the object is moved inwardly with respect to the screen, and the control unit zooms out the display screen when the object is moved outwardly with respect to the screen.
